(19) United States
(12) Patent Application Publication
(10) Pub. No.: US 2015/0028504 A1
(43) Pub. Date: Jan. 29, 2015

(54) QUICK CHANGE MOLD SYSTEM

(71) Applicant: David Frost, Lenox, MA (US)

(72) Inventor: David Frost, Lenox, MA (US)

(21) Appl. No.: 14/110,492

(22) PCT Filed: Apr. 12, 2013
(86) PCT No.: PCT/US13/36277

§ 371 Date: Oct. 8, 2013

Related U.S. Application Data
(60) Provisional application No. 61/636,145, filed on Apr. 20, 2012.

(51) Int. Cl. B29C 33/30

(52) U.S. Cl. CPC B29C 33/305
USPC 264/39; 425/186

(57) ABSTRACT

The system (10) includes a mold (12) with lock pins (18) extending from the mold (12). Each lock pin (18) defines a reduced-diameter lock valley (22) and a wider lock head (24), and is configured to pass through a throughbore (36A, 36b) of a coupling plate (28) of a mold machine (30) and into and through a wide-opening portion (44) of a “butternut-squash” shaped key-slot (42D) defined within a bar (40) of a clamping mechanism (38) adjacent the coupling plate (28). The bar (40) of the clamping mechanism (38) may be selectively moved between a receiving position and a locking position thereby moving the key slot (42D) defined within the bar (40) to engage and release the lock valley (22) to secure and release the lock pin (18) to efficiently secure the mold (12) within, and permit removal of the mold (12) from, a mold machine (30).

### CROSS-REFERENCE TO RELATED APPLICATIONS

This Application claims the benefit of U.S. Provisional Patent Application Ser. No. 61/636,145 that was filed on Apr. 20, 2012 entitled “QUICK CHANGE MOLD SYSTEM”.

### TECHNICAL FIELD

This disclosure relates to molding machines, and in particular relates to a system for rapidly and efficiently moving molds into and out of an injection mold machine.

### BACKGROUND ART

It is known that injection molding processes involve a molding machine, plastic material, and a mold. Most molding machines have some basic structures that allow molds and plastic materials having common standards to be used interchangeably with the machines. One mold machine can accept hundreds of different molds that can be changed hourly, weekly or yearly depending on the need for production of varying parts made by different molds. A typical mold machine includes a frame that supports a fixed platen (which is a flat, firm, strong support surface) and a moving platen that moves within the frame toward the fixed platen. A mold is usually produced in two halves, with a cavity half of the mold secured to the fixed platen, and a core half of the mold secured to the moving platen. The mold machine applies great pressure in sliding the moving platen to force the two mold halves together. Molten plastic, or other moldable material, is then injected into the mold cavity, rapidly cooled, and then the moving platen is pulled away to separate the mold halves so that the cooled plastic part may be removed from the mold. This process is repeated automatically, and it is not uncommon for such mold machines to cycle production of many such parts in one mold having many mold cavities in cycle times of only a few seconds, or less.

After a predetermined number of such parts are produced, it typically becomes desirable to remove the mold from the mold machine and utilize another mold in the same mold machine. The most common way to remove and secure a particular mold in the machine is to use bolts and standard “L-shaped” clamps with a locating ring between the mold and the platens of the mold machine. Once the mold is situated in the machine typically a level is used on top of the mold to make sure the mold is installed level with respect to variability of fastening bolts, clamps, etc. This system while universal can be timely and therefore costly to work because of the alignment of the molds. Moreover, while installing the bolts, nuts and “L-shaped” clamps to secure edges of a mold to a platen, a worker needs access to both sides of the molding machine, which takes time, and gives rise to risk of injury to the worker.

Many efforts have been undertaken to simplify the process of replacing molds within mold machines. Some such molds, for example, those molds utilized in production of large components of automobiles, weigh thousands of pounds and require substantial effort and risk in securing the molds within, and removing the molds out of, a mold machine. For example, U.S. Pat. No. 5,096,404 that issued on Mar. 17, 1992 discloses a “quick mold change arrangement” that includes utilization of slide rails secured to a quick change plate that is affixed to a mold platen. While the guide rails assist lowering a very heavy mold into the machine, the mold nonetheless has to be fastened to the quick change plate with traditional fasteners that are located on both an operator side and a back side of the mold machine. Another “quick change system for mold bases” is disclosed in U.S. Pat. No. 5,562,935 that issued on Oct. 8, 1996. This patent teaches a U-shaped clamp plate that is secured to an adapter plate that includes guide rails and a stop member into which ear plates attached to each half of the mold slide to position the mold within the machine in a correct alignment. After such positioning, however, traditional threaded clamp fasteners are used on both sides of the mold machine to rigidly affix the mold within the machine.

More recently, a “quick mold change clamping plate and support brackets” type of invention was disclosed in U.S. Pat. No. 6,814,560 that issued on Nov. 9, 2004. This Patent teaches use of “double wedges” attached between a clamp plate and a mold, wherein the double wedges are located on opposed sides of the mold. After this system quickly locates correct positioning and alignment of the mold half within the machine, traditional threaded fasteners and “L-shaped” brackets secure the mold to the platen of the mold machine. Similar quick mold change apparatus now also utilize hydraulic clamps that may be variably positioned within elongate slots on clamping plates to hydraulically clamp a mold to the plate until permanent mechanical locks secure the mold to the clamp plate. Such a system is available from the PFA Incorporated company of Germantown, Wis., U.S.A., under the brand name “HYDRA-JAWS Quick Mold Change”. Like the previously described disclosures, however, the “HYDRA JAWS” requires an operator to access the clamp plate from both sides of the mold machine, and to utilize traditional mechanical fasteners after the hydraulic clamps position the mold on the clamp plate.

Other known systems currently on the market use, for example, a bayonet apparatus with a male section on the mold and a female ring plate that is installed in the mold machine. A drawback of this system is a limited load that the bayonet can handle and a substantial expense of manufacturing and maintaining the bayonet apparatus. Additionally, it is common that a first party may own the mold, while a second party is the owner of the mold machine and molding business. Therefore, for economic reasons, many molds are transferred from one molding company to another. Consequently, any mold retention features must be efficiently removable from the mold. Hence, the bayonet apparatus has met with only limited success due to its complexity, cost, and load limitations.

Accordingly there is a need for a system to facilitate more efficient installation and setup of a mold in a mold machine.

### SUMMARY OF THE DISCLOSURE

The disclosure is a system to significantly reduce the time and labor to change molds in a molding machine. The quick change mold system includes a mold that defines a mating surface configured to secure the mating surface to a platen surface of a mold machine. At least one lock pin extends away from the mating surface of the mold, and the lock pin defines an elongate body having a reduced-diameter lock valley in the body. The lock pin also includes a lock head at an end of the lock pin farthest from the mating surface of the mold. The lock head has a longest diameter greater than a longest diameter of the reduced-diameter lock valley. (The phrase “longest diameter” is defined herein to mean a longest straight line across the lock head or across the lock valley, wherein the diameter is parallel to a plane perpendicular to a longitudinal axis of the lock pin. Therefore, the “longest diameter” includes cylindrical and non-cylindrical lock pins, such a rectangular, or octagonal, etc. lock pins.)

The system also includes a coupling plate secured to and adjacent at least one of the platen surfaces of the mold machine, wherein the coupling plate has a front surface and an opposed back surface. The front surface of the coupling plate is configured for engaging and securing the mating surface of the mold to be adjacent the front surface of the coupling plate. The coupling plate defines at least one throughbore dimensioned to permit the lock pin to pass into the throughbore within the coupling plate.

Additionally, the system includes a clamping mechanism that is affixed to the coupling plate. The clamping mechanism includes a bar defining at least one “butternut-squash shaped” key-slot configured so that the key-slot is adjacent the throughbore of the coupling plate. The key-slot includes a wide-opening portion having an adequate diameter to permit the lock head of the lock pin to pass through the wide-opening portion. Adjacent and contiguous with the wide-opening portion is a narrow-opening portion of the key-slot that is configured to permit the narrow-opening portion to slide within the valley defined by the reduced-diameter lock valley of the pin. When the bar moves to position the narrow-opening portion of the key-slot within the valley of the reduced-diameter section of the lock pin, the lock pin is prohibited from movement of the lock head of the pin in a direction away from the front surface of the coupling plate through the narrow-opening portion of the key-slot in the clamping mechanism bar. The clamping mechanism bar is slidably engaged with the coupling plate so that the bar may selectively slide between a receiving position that permits the lock head of the lock pin to pass through the coupling plate throughbore and into the key-slot, and a locking position wherein the bar and key-slot defined within the bar slides to engage the reduced-diameter lock valley in the narrow-opening portion of the key-slot. In the locking position, the lock pin and mold cannot move in a direction away from the front surface of the coupling plate.

The bar of the clamping mechanism may be positioned between the receiving position and the locking position by movement of a handle secured to the bar and extending beyond an exterior perimeter of the coupling plate. A major benefit of the quick change mold system clamping mechanism is that the handle may be moved between positions by an operator accessing the handle from only one side of the mold machine. For purposes of explanation, the coupling plate will therefore be defined to have an operator side and an opposed back side, and the handle extends beyond an exterior perimeter of the operator side of the coupling plate.

The bar of the clamping mechanism may include a plurality of key-slots that are constructed to receive a corresponding plurality of lock pins passing through a corresponding plurality of throughbores defined within the coupling plate. In an embodiment of the present disclosure, the bar of the clamping mechanism may be a circular bar that defines a plurality of key-slots. A handle extends from the circular bar beyond the perimeter of the operator side of the coupling plate so that an operator may move the handle up and down to position the clamping mechanism between the receiving and locking positions. Additionally, the back surface of the coupling plate may define a circular groove dimensioned to receive the bar so that the bar is flush-mounted with the back surface of the coupling plate. Alternatively, the bar may be secured within cooperatively defined passageways within the coupling plate, such as where the coupling plate is formed of two halves, with the passageways for receiving the bar defined in one or both halves, so that the bar is slidably secured within the passageway when the two halves of the coupling plate are joined together.

The bar of the clamping mechanism may also take any form that permits the bar to slidably engage the key-slot with the lock pin as described above. For example, instead of a circular bar, the bar may take the form of a sideways “n” wherein two parallel bars are slidably secured to the coupling plate, and a handle is secured to the bar and extends beyond the operator side perimeter of the coupling plate to move the bar between the locking and receiving positions.

By selectively sliding or activating the clamping mechanism, the mold can very quickly be either captured or released by the mold machine having the coupling plate and clamping mechanism. Activating the clamping mechanism may also work to disengage or engage heating and/or cooling connections, electrical and/or control connections and any information system interface passing from the mold machine into the mold.

Preferably, the lock pin of the system is a pin wherein the reduced-diameter lock valley defined in the pin cuts into approximately 20% of the outer surface of the lock pin forming the reduced-diameter lock valley. The lock pin may be secured to the mold through a standard threaded bolt hole with treads on a mold end of the lock pin, or through a flanged head with a retaining plate, etc. Alternatively, threads may be machined on the end of the lock pin in a manner similar to a standard “shoulder bolt” and then attached to mold. The lock pin optimally protrudes out from the mating surface of the mold a distance that is approximately one hundred percent of the longest diameter of the pin. In other words, a lock pin having a 1″ (one inch) diameter would protrude 1″ from the mating surface of the mold. The coupling plate may also include one or more mounting holes to attach the plate to the platen surface of the mold machine. The coupling plate may also define holes for water lines and passageways for wiring, etc.

Accordingly, it is a general purpose of the present disclosure to provide a quick change mold system that overcomes deficiencies of the prior art.

It is a more specific purpose of the present disclosure to provide quick change mold system that reduces time and effort necessary to change molds and that also enables securing and removing molds from mold machines while accessing the molds from only an operator side of the mold machine. These and other purposes and values of the present disclosure will become apparent in the following detailed description and the accompanying drawings.

### BRIEF DESCRIPTION OF THE DRAWINGS

FIG. 1 is a top perspective view of a mold half secured to a coupling plate attached to a platen surface of a mold machine, showing a handle of a clamping mechanism extending beyond an operator side of the coupling plate and constructed in accordance with the present disclosure.

FIG. 2 is a flat plan view showing a coupling plate and a circular bar of a clamping mechanism secured within a circular groove of the coupling plate and showing a handle of the clamping mechanism secured to the bar and extending beyond an operator side perimeter of the coupling plate.

FIG. 3 is a fragmentary perspective view taken along sight line 3-3 of FIG. 2 showing the circular shaped bar of the clamping mechanism of the present disclosure and showing a reduced diameter valley of a lock pin secured within a narrow-opening portion of a key-slot defined within the bar.

FIG. 4 is an exploded, fragmentary view showing a mold with lock pins extending from a mating surface of the mold, showing a plurality of throughbores defined within a coupling plate adjacent the lock pins, and showing a clamping mechanism displaced from a back surface of the coupling plate.

### PREFERRED EMBODIMENTS OF THE DISCLOSURE

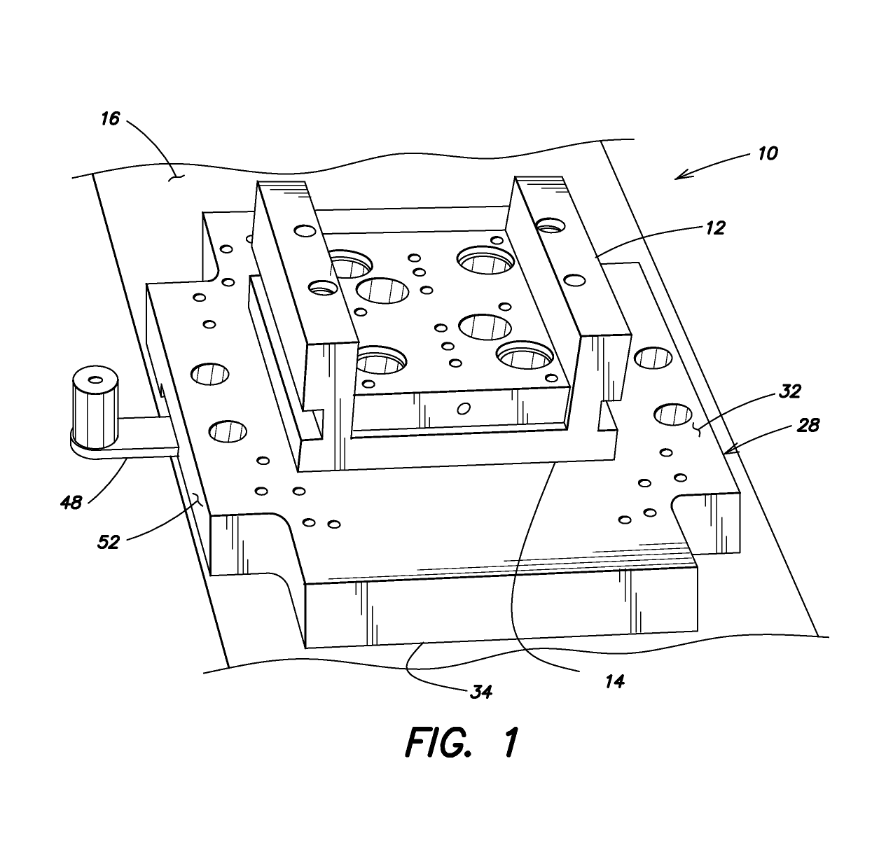

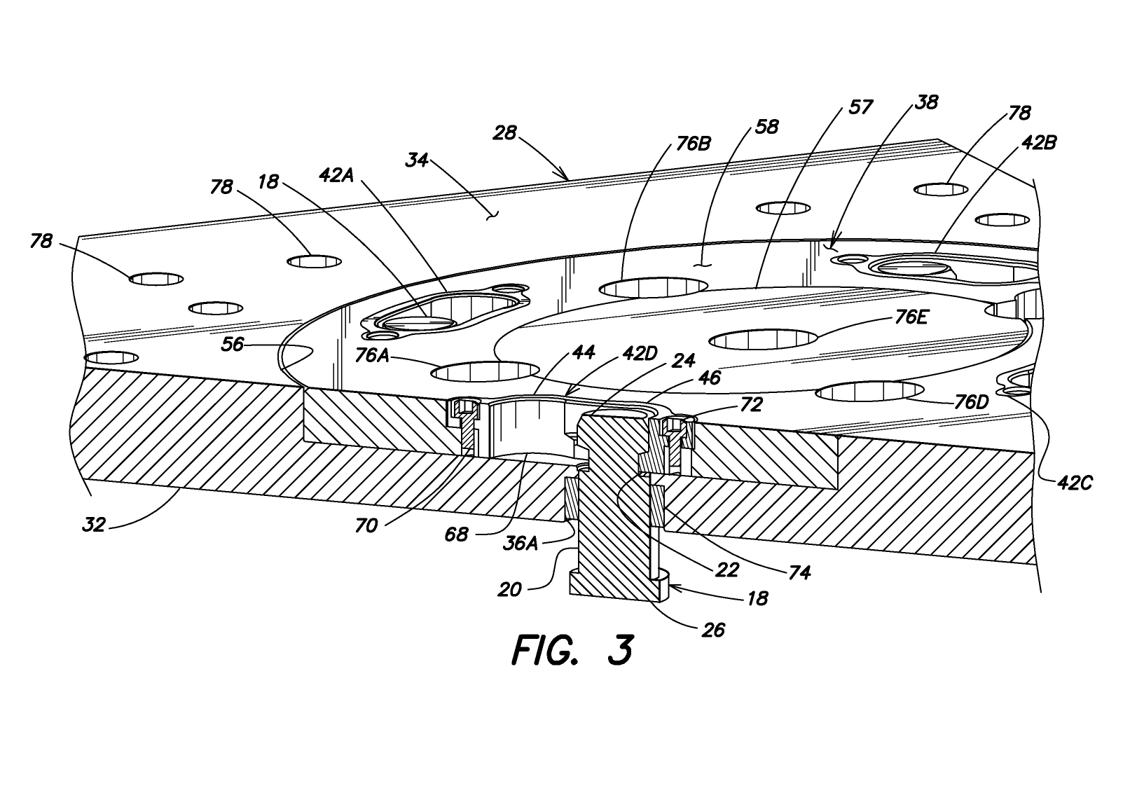

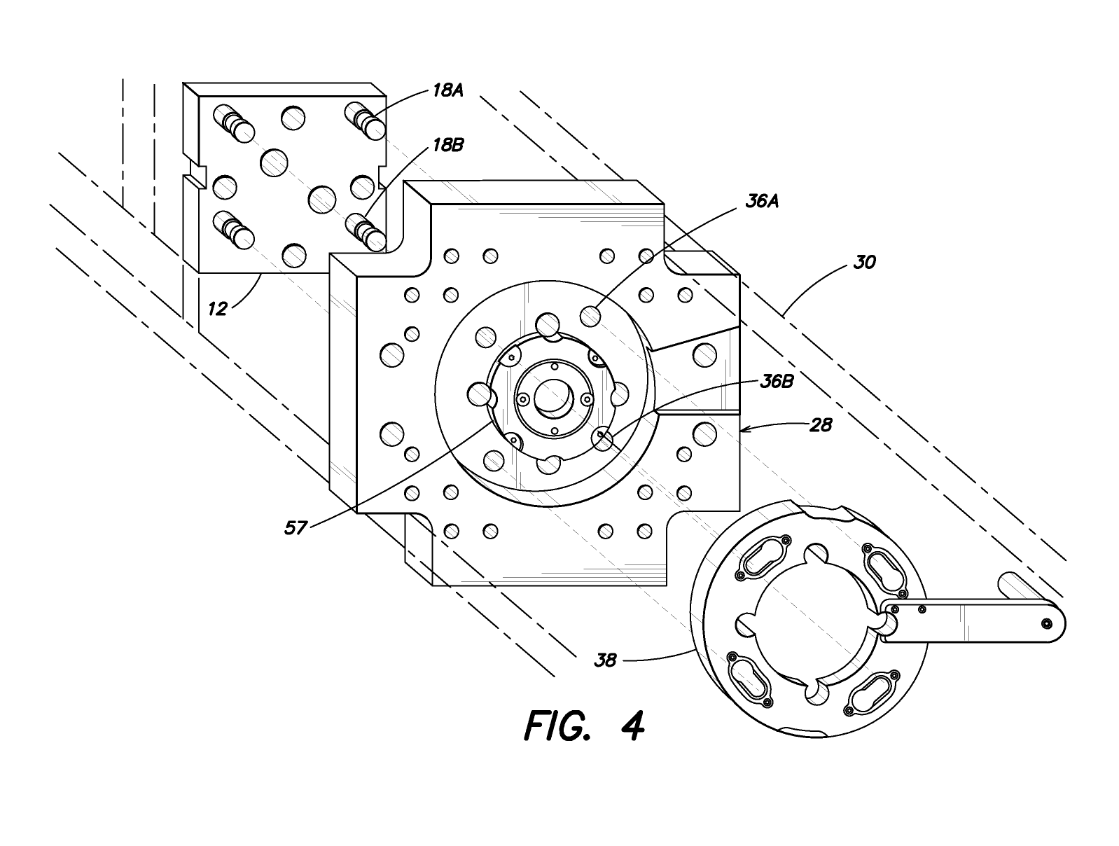

Referring to the drawings in detail, the present quick change mold system is shown in FIGS. 1-4 and is generally designated by reference numeral 10. The system 10 includes a mold 12 that defines a mating surface 14 configured to secure the mating surface 14 to a platen surface 16 of a mold machine. At least one lock pin 18 (shown best in FIG. 3, and also shown in FIG. 4 with reference numerals 18A and 18B) extends away from the mating surface 14 of the mold 12. The lock pin 18 defines an elongate body 20 having a reduced-diameter lock valley 22 in the body 20. The lock pin 18 also includes a lock head 24 at an end of the lock pin 18 farthest from the mating surface 14 of the mold 12. In other words, the reduced-diameter lock valley 22 is between the lock head 24 and a mating surface end 26 of the lock pin 18. As described above, the lock head 24 has a longest diameter greater than a longest diameter of the reduced-diameter lock valley 22. (For purposes herein, the phrase “longest diameter” is defined to mean a longest straight line across the lock head or across the lock valley, wherein the diameter is parallel to a plane perpendicular to a longitudinal axis of the lock pin 18. Therefore, the “longest diameter” includes cylindrical and non-cylindrical lock pins (not shown), such a rectangular, or octagonal, etc. lock pins.)

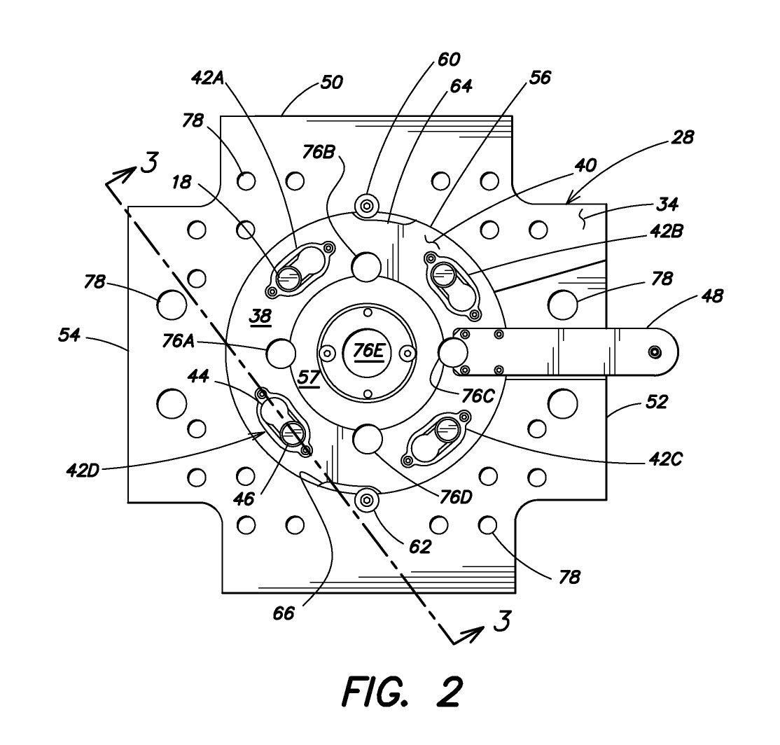

The system 10 also includes a coupling plate 28 secured to and adjacent at least one platen surface 16 of the mold machine 30 (shown in FIG. 4). The coupling plate 28 has a front surface 32 and an opposed back surface 34. The front surface 32 of the coupling plate 28 is configured for engaging and securing the mating surface 14 of the mold 12 to be adjacent the front surface 32 of the coupling plate 28. As best shown in FIGS. 2 and 4, the coupling plate 28 defines at least one throughbore 36A, 36B dimensioned to permit the lock pin 18 to pass into the throughbore 36A within the coupling plate 28.

Additionally, the system 10 includes a clamping mechanism 38 shown best in FIG. 3 that is secured to the coupling plate 28. The clamping mechanism 38 includes a bar 40 defining one or more “butternut-squash shaped” key-slots 42A, 42B, 42C, 42D. The key slots 42A, 42B, 42C, 42D are configured so that, as shown in FIG. 3, each key-slot, such as key-slot 42D, is adjacent a corresponding throughbore 36A of the coupling plate 28. As shown best in FIG. 2, each key-slot 42A, 42B, 42C, 42d, such as key slot 42D in FIGS. 2 and 3 includes a wide-opening portion 44 having an adequate diameter to permit the lock head 24 of the lock pin 18 to pass through the wide-opening portion 44. Adjacent and contiguous with the wide-opening portion 44 is a narrow-opening portion 46 of the key-slot 42D that is configured to permit the narrow-opening portion to slide within the valley 22 defined by the reduced-diameter lock valley 22 of the pin 18. When the bar 40 moves to position the narrow-opening portion 46 of the key-slot 42D within the valley of the reduced-diameter section of the lock pin 18, the lock pin 18 is prohibited from movement of the lock head 24 of the pin 18 in a direction away from the front surface 32 of the coupling plate through the narrow-opening portion 46 of the key-slot 42D in the clamping mechanism 38 bar 40.

The bar 40 of the clamping mechanism 38 is slidably engaged with the coupling plate 28. This means that the bar 40 may selectively slide between a receiving position that permits the lock head 24 of the lock pin 18 to pass through the coupling plate 28 throughbore 36A and into the wide-opening portion 44 of the adjacent key-slot 42D. The slidable bar 40 may then be moved by an operator (not shown) into a locking position wherein the bar 40 and the key-slot 42D defined within the bar 40 slides to engage the reduced-diameter lock valley 22 in the narrow-opening portion 46 of the key-slot 42D. In the locking position, the lock pin 18 and mold 12 secured to the lock pin 18 cannot move in a direction away from the front surface 32 of the coupling plate 28.

The bar 40 of the clamping mechanism 38 may be moved between the described receiving and locking positions by movement of a handle 48 secured to the bar 40 and extending beyond an exterior perimeter 50 of the coupling plate 28. As described above, a major benefit of the quick change mold system 10 clamping mechanism 38 is that the handle 48 may be moved between the receiving and locking positions by an operator (not shown) accessing the handle 48 from only one side of the quick mold change system 10. As shown in FIG. 2, the coupling plate 28 will therefore be defined to have an operator side 52 and an opposed back side 54, and the handle 48 extends beyond the exterior perimeter 50 of the operator side 52 of the coupling plate 28.

In an embodiment of the present disclosure, the bar 40 of the clamping mechanism 38 may be a circular bar 40 that defines the plurality of key-slots 42A, 42B, 42C, 42D. Additionally, the back surface 34 of the coupling plate 28 may define a circular groove 56 surrounding a central ring 57 of the back surface 34. The circular groove 56 is dimensioned to receive the bar 40 so that the bar is flush-mounted with the back surface 34 of the coupling plate 28. Being “flush-mounted” means that the back surface 34 of the coupling plate 28 and an outer surface 58 of the bar 40 are co-planar. This facilitates assembly of the system 10 adjacent the planar platen surface 16. Prior to securing the coupling plate 28 to the platen surface 16, the bar 40 may be retained within the coupling plate 28 by any retaining means for securing the bar 40 within the plate 28 while permitting the bar 40 to be slidably secured adjacent or within the plate 28. For example and as shown in FIG. 2, the retaining means may include a first retention washer 60 and a second retaining washer 62 secured to the coupling plate 28 adjacent the circular groove 56 and overlying a first retention slot 64 and a second retention slot 66. The slots 64, 66 are dimensioned to permit slidable rotation of the circular bar 40.

Alternatively, the bar 40 may be secured within cooperatively defined passageways (not shown) within the coupling plate 28, such as where the coupling plate 28 is formed of two halves (not shown), with the passageways for receiving the bar 40 defined in one or both halves, so that the bar is slidably secured within the passageway when the two halves of the coupling plate 28 are joined together. As described above, in alternative embodiments, the bar 40 may be one or more straight bars (not shown) slidably secured within the coupling plate 28, and defining similar key-slots to engage lock pins 18. In other words, the disclosure is not limited to the efficient circular bar 40 shown in FIGS. 2 and 3, and may take the form of a sideways “n” wherein two parallel bars (not shown) are slidably secured to or within the coupling plate 28, and a handle is secured to the bar and extends beyond the operator side 52 perimeter of the coupling plate 28 to move the bar between positions for receiving the lock pin 18 and locking the lock pin 18 by slidably engaging a narrow portion of a key slot in the lock valley 22 of the lock pin 18.

As best shown in FIG. 3 the clamping mechanism 38 may include a removable key-slot liner 68 secured by a first liner fastener 70 and second liner fastener 72. The removable key-slot liner 68 defines the wide-opening portion 44 and narrow-opening portion 46 of the key-slot 42D so that different removable key-slot liners may be secured within the key-slots 42A, 42B, 42C, 42D to mate effectively with variable sized lock pins 18. As also shown in FIG. 3 the throughbore 36A of the coupling plate 28 may include a replaceable bushing liner 74 to provide additional support for variable sized lock pins 18. FIGS. 2 and 3 also show a plurality of intra-mold throughbores 76A, 76B, 76C, 76D, 76E that may be utilized to provide access for pins or rods used to push out a completed mold product (not shown). FIGS. 2 and 3 also show a plurality of coupling plate 28 service throughbores 78 for permitting pass through of fasteners to secure the coupling plate 28 to the platen surface 16, and for other plate service functions known in the art.

By selectively sliding or activating the clamping mechanism 38, the mold can very quickly be either captured or released by the mold machine 30 having the coupling plate 28 and clamping mechanism 38. Activating the clamping mechanism may also work to disengage or engage heating and/or cooling connections, electrical and/or control connections and any information system interface passing from the mold machine 30 through the coupling plate 28 and into the mold 12.

Preferably, the lock pin 18 of the system 10 is a pin 18 wherein the reduced-diameter lock valley 22 defined in the pin 18 encircles the pin 18 and cuts into approximately 20% of a diameter of the body 20 of the lock pin 18 to thereby form the reduced-diameter lock valley 22. The lock pin 18 may be secured to the mating surface 14 the mold 12 through standard fastening means, such as threaded bolts and corresponding holes, etc. on a mating surface end 26 of the lock pin 18, or through a flanged head with a retaining plate (not shown), etc. The lock pin 18 optimally protrudes out from the mating surface 14 of the mold 12 a distance that is at least approximately one hundred percent of the longest diameter of the pin 18. In other words, a lock pin having a one inch diameter would protrude at least one inch from the mating surface 14 of the mold 12. Also, the quick change mold system 10 may include a handle-lock (not shown) for securing the handle 48 in a locked position while the mold 12 is secured within the mold machine 30.

The present disclosure also includes methods of using the quick change mold system 10 to efficiently secure a mold 12 or mold-half 12 to, and remove the mold 12 or mold-half from the mold machine 30. The method of using the quick change mold system 10 includes positioning the bar 40 of the clamping mechanism 38 in a receiving position so that the lock head 24 of at least one lock pin 18 passes through a throughbore in the coupling plate 28 and then passes through the wide-opening portion 44 of the key-slot 42D defined within the bar 40. Then, the bar 40 is positioned in the locking position wherein the narrow-opening portion 46 of the key-slot 42D engages the lock valley 22 of the lock pin 18 to thereby prevent the lock pin 18 and the mold 12 secured to the lock pin 18 from moving in a direction away from the coupling plate 28, and from moving in any direction. The method also includes removing the mold 12 from the mold machine 30 by positioning the bar 40 back in the receiving position so that the wide-opening portion 44 of the key-slot 42D is moved to surround the lock valley 22 and lock head 24 of the lock pin 18. Then, the mold 12 can simply be pulled away from the coupling plate 28 so that the at least one lock pin 18 passes out of the key-slot 42D and adjacent throughbore 36A of the coupling plate 28 to thereby release the mold 12 from the molding machine 30.

While the present disclosure has been presented above with respect to the described and illustrated embodiments of quick change mold system, it is to be understood that the disclosure is not to be limited to those alternatives and described embodiments. For example, while a traditional “molding machine” is an plastic injection molding machine, it is to be understood that the present disclosure is to include any machine that secures a mold 12 within the machine. Additionally, optimal use of the quick change mold system 10 would be that both a stationary platen surface 16 and a movable plate surface (not shown) would include quick change mold systems 10. In other words, a cavity half of the mold 12 would be secured to the stationary platen surface 16 by the quick change mold system 10, as described above. And within the same molding machine 30, a core half (not shown) of the mold would be secured by a second and virtually identical quick change mold system (not shown) to the moving platen surface (not shown) that moves the core half of the mold into contact with the cavity half of the mold 12, in a manner known in the art. Accordingly, reference should be made primarily to the following claims rather than the forgoing description to determine the scope of the disclosure.

What is claimed is:

1. A quick change mold system for changing molds within a mold machine, the system comprising:
a. a mold defining a mating surface configured to secure the mold to a platen surface of a mold machine;
b. at least one lock pin extending away from the mating surface of the mold, wherein the at least one lock pin defines an elongate body having a reduced-diameter lock valley in the body, the lock pin including a lock head at an end of the lock pin farthest from the mating surface of the mold wherein the lock head has a longest diameter greater than a longest diameter of the reduced-diameter of the lock valley;
c. a coupling plate secured to the platen surface of the molding machine, the coupling plate having a front surface for engaging and securing the mating surface of the mold adjacent the front surface of the coupling plate, the coupling plate having an opposed back surface secured adjacent the platen surface, the coupling plate defining at least one throughbore dimensioned to permit the at least one lock pin to pass into the coupling plate; and,
d. a clamping mechanism affixed to the coupling plate, the clamping mechanism including a bar defining at least one key slot and configured so that the key slot is adjacent the at least one throughbore of the coupling plate, wherein the at least one key slot includes a wide-opening portion having an adequate diameter to permit the lock head of the lock pin to pass through the wide-opening portion, the key slot having an adjacent and contiguous narrow-opening portion configured to slide around and engage the reduced-diameter lock valley of the pin to thereby prohibit movement of the lock head and mold in a direction away from the coupling plate and clamping mechanism through the narrow-opening portion, and the bar being slidably engaged with the coupling plate so that the bar may selectively slide between a receiving position permitting the lock head of the lock pin to pass through the coupling plate throughbore and into the key slot, and a locking position wherein the key slot defined within the bar slides to engage the reduced-diameter lock valley in the narrow-opening portion of the key slot so that the locking pin and mold cannot move relative to the coupling plate.

2. The quick change mold system of claim 1, further comprising the clamping mechanism including a handle secured to the bar, wherein the handle extends away from the bar and beyond an exterior perimeter of the coupling plate on an operator side of the coupling plate.

3. The quick change mold system of claim 2, wherein the bar further comprises a circular bar.

4. The quick change mold system of claim 3, wherein the circular bar is secured within a circular groove defined within the back surface of the coupling plate and wherein the circular groove is dimensioned to receive the circular bar so that the bar is flush-mounted with the back surface of the coupling plate.

5. The quick change mold system of claim 1, wherein the reduced-diameter lock valley of the at least one lock pin defined in the body of the pin encircles the pin and cuts into approximately twenty percent of a diameter of the body of the lock pin to thereby form the reduced-diameter lock valley.

6. The quick change mold system of claim 1, wherein the lock pin protrudes out and away from the mating surface of the mold a distance that is at least one hundred percent of the longest diameter of the lock pin.

7. The quick change mold system of claim 1, wherein the mating surface of the mold includes a plurality of lock pins extending away from the mating surface, the coupling plate defines a plurality of throughbores configured to permit the each of the plurality of lock pins to pass into an adjacent one of the plurality of throughbores, and the bar defines a plurality of key slots configured so that each of the plurality of key slots is adjacent one of the plurality of throughbores of the coupling plate.

8. The quick change mold system of claim 1, further comprising at least one removable key-slot liner secured within the at least one key-slot of the bar and defining the wide-opening portion and the narrow-opening portion of the at least one key-slot, the removable key-slot liner being removable from the key-slot.

9. A method of operating a quick change mold system, the method comprising:
a. securing to a coupling plate attached to a platen surface of a mold machine a mold having at least one lock pin extending away from a mating surface of the mold by sliding a bar of a clamping mechanism to position the bar in a receiving position so that a lock head of the at least one lock pin passes through a throughbore in the coupling plate supporting the clamping mechanism and so that the lock head then passes through a wide-opening portion of a key-slot defined within the bar; and,
b. then, sliding the bar to position the bar in a locking position wherein a narrow-opening portion of the key-slot engages a lock valley of the lock pin to thereby prevent the lock pin and the mold secured to the lock pin from moving in a direction away from the coupling plate, and from moving in any direction.

10. The method of operating a quick change mold system of claim 9, further comprising:
a. removing the mold from the mold machine by sliding the bar to position the bar back in the receiving position so that the wide-opening portion of the key-slot is moved to surround the lock valley and lock head of the lock pin; and,
b. then, pulling the mold away from the coupling plate an adequate distance so that the at least one lock pin passes out of the key-slot of the bar and out of the adjacent throughbore of the coupling plate to thereby remove the mold from the molding machine.
